(19) United States
(12) Patent Application Publication
(10) Pub. No.: US 2025/0356631 A1
(43) Pub. Date: Nov. 20, 2025

(54) DATA PROCESSING METHOD, ELECTRONIC DEVICE, AND STORAGE MEDIUM

(71) Applicant: Lenovo (Beijing) Limited, Beijing (CN)

(72) Inventors: Haotian YUAN, Beijing (CN); Ziyao YU, Beijing (CN); Qihua XIAO, Beijing (CN)

(21) Appl. No.: 19/204,594

(22) Filed: May 11, 2025

(30) Foreign Application Priority Data
May 14, 2024 (CN) 202410599302.9

(51) Int. Cl. G06V 10/77; G06V 10/82

(52) U.S. Cl. CPC G06V 10/7715; G06V 10/82

(57) ABSTRACT

A data processing method includes obtaining input data, and using a local data processing model of an electronic device to locally process the input data to obtain target data. The electronic device includes a neural network processor. The local data processing model runs on the neural network processor, and thereby the local data processing model expediates local processing of the input data.

### CROSS-REFERENCES TO RELATED APPLICATIONS

The present disclosure claims priority of Chinese Patent Application No. 202410599302.9, filed on May 14, 2024, the entire content of which is hereby incorporated by reference.

### FIELD OF THE DISCLOSURE

The present disclosure generally relates to the field of data processing technology and, more particularly, relates to a data processing method, a neural network processor, and an electronic device.

### BACKGROUND

Nowadays, the amount of computation in a computing module for an AI model may be huge. Computing modules for AI models are usually deployed on the cloud. Deploying a computing module on a local device may make an AI model unable to operate.

### SUMMARY

One aspect of the present disclosure includes a data processing method. The data processing method includes: obtaining input data; based on the input data, determining an image feature vector and a text feature vector; inputting the image feature vector into a first processing unit local to an electronic device, to obtain an image feature vector output by the first processing unit; inputting the text feature vector and the image feature vector output by the first processing unit into a second processing unit local to the electronic device, where the second processing unit is configured to, according to correlation between the text feature vector and the image feature vector output by the first processing unit, adjust the image feature vector output by the first processing unit, and then input the image feature vector after adjustment by the second processing unit into a next first processing unit local to the electronic device; and based on processing by a plurality of the first processing units and a plurality of the second processing units, obtaining target data. Vector sizes of the image feature vectors processed by different first processing units of the first processing units are same or different, and thereby vector sizes of the image feature vectors processed by the second processing units are same or different. A quantity of times the second processing units process the image feature vectors with a large vector size is less than a quantity of times the second processing units process the image feature vectors with a small vector size.

Another aspect of the present disclosure includes an electronic device. The electronic device includes one or more processors and a memory containing a computer program that, when being executed, causes the one or more processors to perform: obtaining input data; based on the input data, determining an image feature vector and a text feature vector; and inputting the image feature vector into a first processing unit local to an electronic device, to obtain an image feature vector output by the first processing unit; inputting the text feature vector and the image feature vector output by the first processing unit into a second processing unit local to the electronic device. The second processing unit is configured to, according to correlation between the text feature vector and the image feature vector output by the first processing unit, adjust the image feature vector output by the first processing unit, and then input the image feature vector after an adjustment by the second processing unit into a next first processing unit local to the electronic device. The one or more processors are further configured to perform: based on processing by a plurality of the first processing units and a plurality of the second processing units, obtaining target data, the target data being related to the input data. Vector sizes of the image feature vectors processed by different first processing units are same or different, and thereby vector sizes of the image feature vectors processed by the second processing units are same or different. A quantity of times the second processing units process the image feature vectors with a large vector size is less than a quantity of times the second processing units process the image feature vectors with a small vector size.

Another aspect of the present disclosure includes a non-transitory computer readable storage medium containing a computer program that, when being executed, causes at least one processor to perform: obtaining input data; based on the input data, determining an image feature vector and a text feature vector; and inputting the image feature vector into a first processing unit local to an electronic device, to obtain an image feature vector output by the first processing unit; inputting the text feature vector and the image feature vector output by the first processing unit into a second processing unit local to the electronic device. The second processing unit is configured to, according to correlation between the text feature vector and the image feature vector output by the first processing unit, adjust the image feature vector output by the first processing unit, and then input the image feature vector after an adjustment by the second processing unit into a next first processing unit local to the electronic device. The at least one processor is further configured to perform: based on processing by a plurality of the first processing units and a plurality of the second processing units, obtaining target data, the target data being related to the input data. Vector sizes of the image feature vectors processed by different first processing units are same or different, and thereby vector sizes of the image feature vectors processed by the second processing units are same or different. A quantity of times the second processing units process the image feature vectors with a large vector size is less than a quantity of times the second processing units process the image feature vectors with a small vector size.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of a data processing method consistent with the disclosed embodiments of the present disclosure;

FIG. 2 illustrates a schematic structural diagram of a data processing model run by a neural network processor, consistent with the disclosed embodiments of the present disclosure;

FIG. 3 illustrates a flow chart of another data processing method consistent with the disclosed embodiments of the present disclosure;

FIG. 4 illustrates a partial schematic structural diagram of a first processing unit and a second processing unit local to an electronic device, consistent with the disclosed embodiments of the present disclosure;

FIG. 5 illustrates a schematic deployment diagram of a first processing unit and a second processing unit local to an electronic device, consistent with the disclosed embodiments of the present disclosure;

FIG. 6 illustrates another schematic deployment diagram of a first processing unit and a second processing unit local to an electronic device, consistent with the disclosed embodiments of the present disclosure;

FIG. 7 illustrates a flow chart for adjusting a target ratio, consistent with the disclosed embodiments of the present disclosure;

FIG. 8 illustrates a schematic structural diagram of an electronic device consistent with the disclosed embodiments of the present disclosure;

FIG. 9 illustrates a schematic structural diagram of an image generation model local to an electronic device, consistent with the disclosed embodiments of the present disclosure; and

FIG. 10 illustrates a schematic diagram of an image generation model in existing technology.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

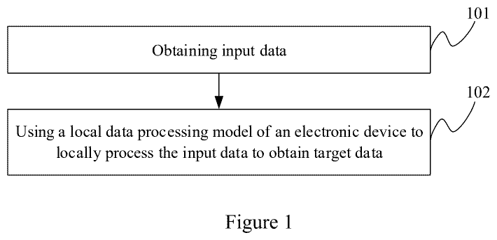

The present disclosure provides a data processing method. FIG. 1 illustrates a flow chart of a data processing method consistent with the disclosed embodiments of the present disclosure. The data processing method may be applied to electronic devices capable of data processing, such as mobile phones, tablet devices, notebooks or servers. The technical solution of the present disclosure is mainly to improve the reliability of data processing. Specifically, in one embodiment, as shown in FIG. 1, the data processing method may include operations S101 and S102.

S101: obtaining input data. The input data may include an input image and/or an input text.

In one implementation, the input image may be a noise image such as a blank image, or the input image may be an original image to be processed, with noise added. The input text may be a text representing an intention of data processing. The input text may be input in form of characters, or the input text may be input in form of voice.

Taking an image generation scenario as an example, the input image is an image with added noise. The input text is a text entered by a user through an interactive interface, such as “a tabby cat” entered by the user in an input box. The image with added noise may be a pure noise image such as a blank image, or an original image with added noise. The original image is input by a user. Alternatively, the input text is a text generated during application execution, such as a description text in a novel: “the visitor has long black hair.”

Taking a text generation scenario as an example, the text may be a text entered by a user through an interactive interface, such as “an opening speech” entered by the user in an input box, or a text generated during application execution, such as a descriptive text in an article summary: “conclusion”.

S102: using a local data processing model of an electronic device to locally process the input data to obtain target data. The target data is related to the input data. The electronic device may include a neural network processor (NPU). The local data processing model operates on the neural network processor, such that the local data processing model may expediate the local processing of the input data.

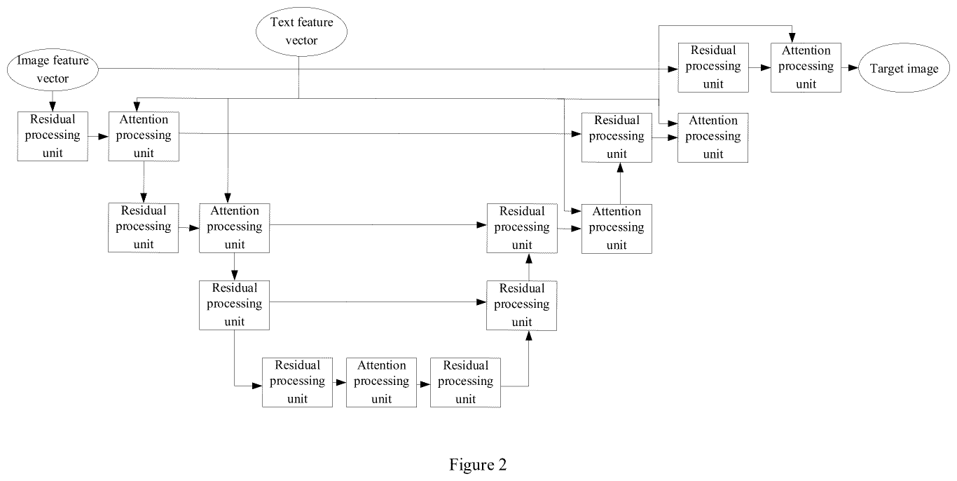

It should be noted that the local data processing model may be an image generation model or a text generation model. The local data processing model may include a plurality of processing units. FIG. 2 illustrates a schematic structural diagram of a data processing model run by a neural network processor, consistent with the disclosed embodiments of the present disclosure. Taking the image generation model as an example, as shown in FIG. 2, the image generation model includes a residual processing unit and an attention processing unit. The residual processing unit is configured to process an input image feature vector, such that the input image feature vector may be denoised. Specifically, the processing may include convolution, pooling, max pooling, relu and other processing. The residual processing unit outputs a denoised image feature vector. The attention processing unit is configured to, according to the correlation between the input text feature vector and the image feature vector output by the residual processing unit connected to the attention processing unit, adjust the image feature vector output by the residual processing unit, such that the image feature vector output by the attention processing unit and the input text feature vector may meet a correlation condition. Afterwards, the attention processing unit inputs the output image feature vector into the next residual processing unit in the local processing model, and so on, until the local image generation model generates the target image (i.e., target data) based on the image feature vector output by the last attention processing unit or residual processing model.

Specifically, in one embodiment, the local data processing model may be tuned and trained in the neural network processor. The inference framework of the neural network processor may be used to implement a dedicated expediated data processing model, that is, an NPU dedicated large model, such as an NPU large model dedicated to image generation or an NPU large model dedicated to text generation.

It may be learnt from the above descriptions that, in one embodiment, in the data processing method, the local data processing model may be executed through a neural network processor in an electronic device, such that the local data processing model may expediate the local processing of the input data. As such, the neural network processor may be used to expediate the operation of the local data processing model. Accordingly, the situation where the data processing model may not be locally executed, may be avoided, and the reliability of data processing may be improved.

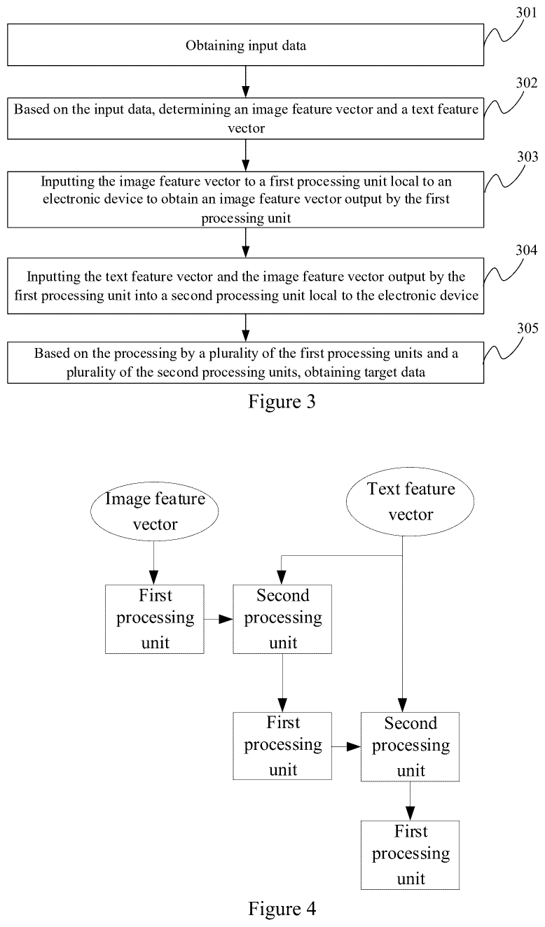

FIG. 3 illustrates a flow chart of another data processing method consistent with the disclosed embodiments of the present disclosure. The data processing method may be applied to electronic devices capable of data processing, such as mobile phones, tablet devices, notebooks or servers, for improving the reliability of data processing. Specifically, referring to FIG. 3, in one embodiment, the data processing method may include operations S301-S305.

S301: obtaining input data. The input data may include an input image and/or an input text.

In one implementation, the input image may be a noise image such as a blank image, or the input image may be an original image to be processed, with noise added. The input text may be a text representing an intention of data processing. The input text may be input in form of characters, or the input text may be input in form of voice.

Taking an image generation scenario as an example, the input image is an image with added noise. The input text is a text entered by a user through an interactive interface, such as “a tabby cat” entered by the user in an input box. Alternatively, the input text is a text generated during application execution, such as a description text in a novel: “the visitor has long black hair.”

Taking a text generation scenario as an example, the text may be a text entered by a user through an interactive interface, such as “an opening speech” entered by the user in an input box, or a text generated during application execution, such as a descriptive text in an article summary: “conclusion”.

S302: based on the input data, determining an image feature vector and a text feature vector. The image feature vector may be obtained by extracting features from the input image in the input data. The text feature vector may be obtained by extracting features from the input text in the input data.

S303: inputting the image feature vector to a first processing unit local to an electronic device to obtain an image feature vector output by the first processing unit. Taking the first processing unit as a residual processing unit as an example, the first processing unit is configured to process the input image feature vector such that the input image feature vector may be denoised. Specifically, the processing may include convolution, pooling, max pooling, relu and other processing, such that the first processing unit may output a denoised image feature vector.

As such, after being processed by at least one first processing unit, an image feature vector output by the first processing unit may be obtained.

S304: inputting the text feature vector and the image feature vector output by the first processing unit into a second processing unit local to the electronic device.

The image feature vector output by the first processing unit is an image feature vector obtained after being processed by one first processing unit, and may also be an image feature vector obtained after being processed by a plurality of first processing units. FIG. 4 illustrates a partial schematic structural diagram of a first processing unit and a second processing unit local to an electronic device, consistent with the disclosed embodiments of the present disclosure. As shown in FIG. 4, the second processing unit is configured to adjust the image feature vector output by the first processing unit according to the correlation between the text feature vector and the image feature vector output by the first processing unit, and then input the adjusted image feature vector to a next first processing unit local to the electronic device.

Taking the second processing unit as an attention processing unit as an example, the second processing unit may, according to the correlation between the input text feature vector and the image feature vector output by the residual processing unit connected to the attention processing unit, adjust the image feature vector output by the residual processing unit, such that the image feature vector output by the second processing unit and the input text feature vector may meet a correlation condition. Afterwards, the attention processing unit inputs the output image feature vector into a next residual processing unit in the local processing model.

The correlation condition may be that the similarity between the image feature vector output by the second processing unit and the input text feature vector is greater than or equal to a similarity threshold.

S305: based on the processing by a plurality of the first processing units and a plurality of the second processing units, obtaining target data.

The target data is related to the input data. The electronic device may be locally deployed with a plurality of first processing units and a plurality of second processing units, and other processing units may also be deployed. The processing units in the electronic device may be deployed independently or centrally in a data processing model. Based on this, the processing units deployed in the electronic device may process the image feature vector and the text feature vector. After processing by the processing units, the corresponding target data may be obtained.

In addition, the vector sizes of the image feature vectors processed by different first processing units may be same or different. The vector sizes of the image feature vectors processed by the second processing units may be same or different. The number of times the second processing units process the image feature vectors with large vector sizes may be less than the number of times the second processing units process the image feature vectors with small vector sizes. That is, the number of the second processing units processing the image feature vectors with large vector sizes may be less than the number of the second processing units processing the image feature vectors with small vector sizes.

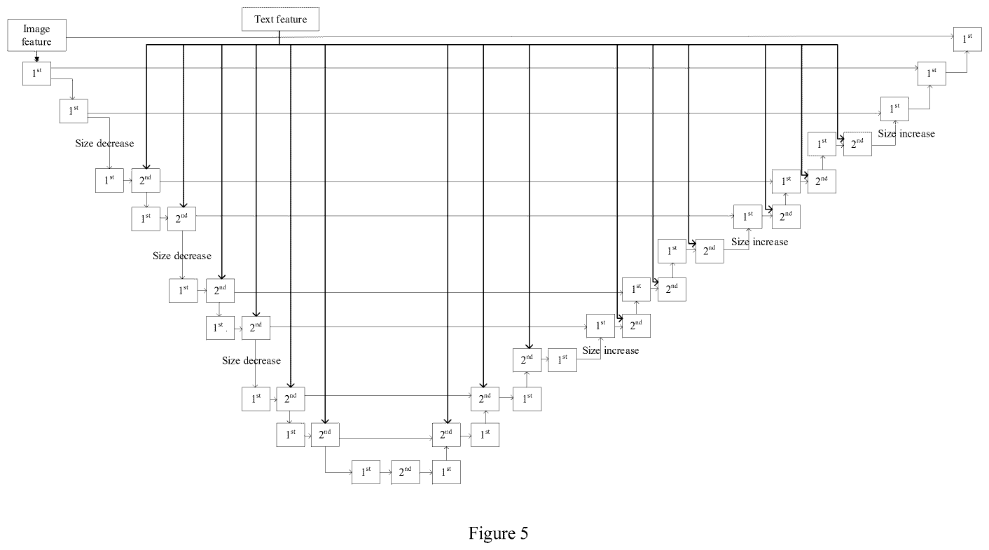

FIG. 5 illustrates a schematic deployment diagram of a first processing unit and a second processing unit local to an electronic device, consistent with the disclosed embodiments of the present disclosure. As shown in FIG. 5, the processing units locally deployed in the electronic device at least include a plurality of first processing units and a plurality of second processing units. The first processing unit may be a residual processing unit, such as a processing module based on resnet. The second processing unit may be an attention processing unit, such as a processing module based on cross attention. The processing units deployed locally on the electronic device may be used to implement image generation or text generation. For example, the electronic device may be locally deployed with a data processing model, and the local data processing model may be an image generation model or a text generation model.

In a specific implementation, the processing unit locally deployed in the electronic device may be a Unet structure. As shown in FIG. 5, the text feature vector corresponding to the input data is the input for each second processing unit. The image feature vector corresponding to the input data is the input for the first first-processing unit on the left. The first first-processing unit processes the image feature vector and inputs the image feature vector obtained into the second first-processing unit. The second first-processing unit processes the input image feature vector, reduces the vector size of the obtained image feature vector, and then inputs the image feature vector into the third first-processing unit. The third first-processing unit processes the image feature vector and inputs the obtained image feature vector into the first second-processing unit. The first second-processing unit adjusts the input image feature vector according to the correlation between the input text feature vector and the input image feature vector, and inputs the adjusted image feature vector to the fourth first-processing unit. The fourth first-processing unit processes the image feature vector and inputs the obtained image feature vector into the second second-processing unit. The second second-processing unit adjusts the input image feature vector according to the correlation between the input text feature data and the input image feature vector, reduces the vector size of the adjusted image feature vector and inputs the image feature vector to the fifth first-processing unit. The fifth first-processing unit processes the image feature vector, and inputs the obtained image feature vector into the third second-processing unit; and so on, until the thirteenth first-processing unit processes the image feature vector, increases the vector size of the obtained image feature vector, and then inputs the image feature vector into the fourteenth first-processing unit.

The fourteenth first-processing unit processes the image feature vector, and inputs the obtained image feature vector into the ninth second-processing unit. The ninth second-processing unit adjusts the input image feature vector according to the correlation between the input text feature data and the input image feature vector, and then inputs the adjusted image feature vector to the fifteenth first-processing unit, and so on, until the last first processing unit processes the image feature vector and outputs the obtained image feature vector. The target data may be obtained according to the output image feature, such as a target image generated according to the input text in the input data.

As may be seen from FIG. 5, the number of the second processing units processing the image feature vectors with a large vector size is smaller than the number of second processing units processing the image feature vectors with a small vector size. Since the amount of data processing for processing an image feature vector with a large vector size is large, and the number of second processing units for processing the image feature vectors with a large vector size is small, the number of times the second processing unit processes the image feature vector with a large vector size may be reduced, and the local resource consumption of the electronic device may be reduced.

It may be seen from the above descriptions that in the data processing method provided by the present disclosure, a plurality of first processing units is locally deployed in the electronic device, and a second processing unit is deployed for a part of the first processing units. On this basis, the number of second processing units that process image feature vectors with a large vector size may be reduced. As such, the resource consumption caused by the second processing units processing the image feature vectors may be reduced, and the local processing units may expediate the local processing of the image feature vectors. Accordingly, the local resource consumption may be reduced by reducing the number of locally deployed processing units for processing image feature vectors with a large vector size, and the operation of the local processing units may be expediated. The situation where the processing units may not be locally operated, may be avoided, the reliability of data processing may be improved.

In one implementation, the second processing units are classified into a plurality of layers according to the vector sizes of the image feature vectors the second processing units process, and the number of second processing units in each layer is set following a target ratio.

For example, the image feature vectors processed by the local second processing units in the electronic device have three vector sizes. According to the three vector sizes, the local second processing units may be classified into three layers. The numbers of the second processing units included in the layer corresponding to the large vector size, the layer corresponding to the medium vector size, and the layer corresponding to the small vector size have ratio relationships given by 1:2:4. As such, the number of second processing units processing the image feature vectors with a small vector size is the largest, and the number of second processing units processing the image feature vectors with a large vector size is the smallest. The local resource consumption may be reduced by reducing the number of locally deployed processing units for processing the image feature vectors with a large vector size. Simultaneously, the number of locally deployed processing units for processing the image feature vectors with a small vector size may be increased. Accordingly, the processing quality of the image feature vectors may be improved, the operation of the local processing units may be expediated, and the data quality of the obtained target data may be improved.

Based on the above implementation, the first processing units and the second processing units operate on a processor of the electronic device. The processor may be a neural network processor, the target ratio is related to the processing performance of the processor. The processing performance of the processor may include at least one of the following: the size of the cache space of the processor, and the computing power of the computing unit of the processor. Taking the processor as an NPU as an example, the cache space of the processor may be the size of the L1 region in the cascade cache of the NPU, and the computing power of the computing unit of the processor may be the core size of the NPU.

For example, the smaller the cache space of the processor and/or the lower the computing power of the computing unit of the processor, in the target ratio, the smaller the number of the second processing units locally deployed to process the image feature vectors with a large vector size. When the cache space of the processor is large and/or the computing power of the computing unit of the processor is strong, in the target ratio, the number of the second processing units locally deployed to process the image feature vectors with a large vector size may be increased, but may not be greater than the number of the second processing units for processing the image feature vectors with a small vector size.

In addition, the target ratio may also be related to the data size of the target data. Taking the target data as image data as an example, the data size of the target data may be the image resolution of the target image. For example, the larger the target data is, in the target ratio, the smaller the number of the second processing units locally deployed for processing the image feature vectors of a large vector size is. When the target data is small, in the target ratio, the number of second processing units locally deployed to process the image feature vectors with a large vector size may be increased, but may not exceed the number of second processing units for processing the image feature vectors with a small vector size.

In one implementation, the electronic device may also include a third processing unit locally deployed between two adjacent first processing units. Alternatively, the third processing unit may be deployed between a first processing unit and a second processing unit adjacent to the first processing unit.

The third processing unit is configured to upsample (US) the image feature vector output by the second processing unit or the first processing unit to obtain an image feature vector with an increased vector size, and provide the image feature vector with an increased vector size to a next first processing unit, that is, input the image feature vector with an increased vector size to a next first processing unit adjacent to the third processing unit.

Alternatively, the third processing unit is configured to downsample (DS) the image feature vector output by the second processing unit or the first processing unit to obtain an image feature vector with a reduced vector size, and provide the image feature vector with a reduced vector size to a next first processing unit, that is, input the image feature vector with a reduced vector size reduced to a next first processing unit adjacent to the third processing unit.

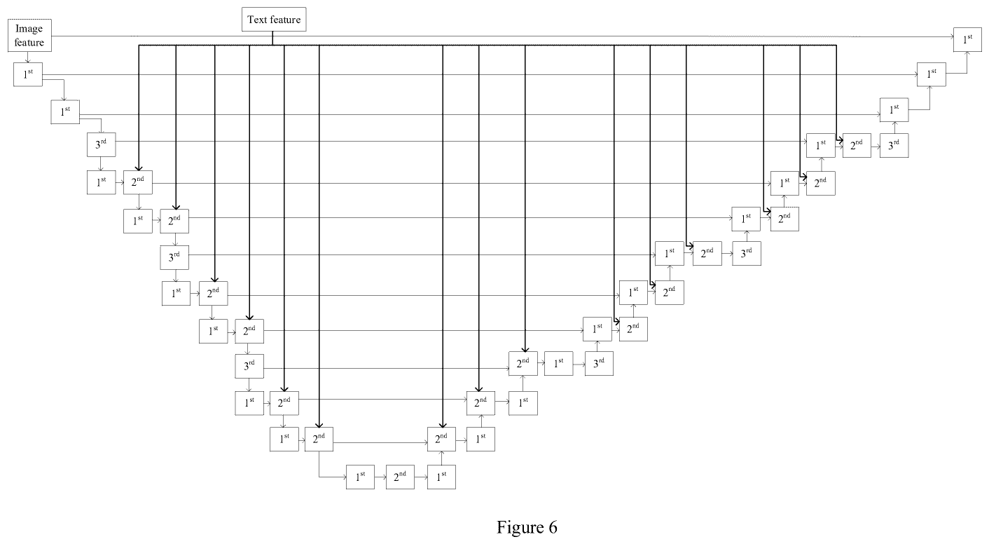

FIG. 6 illustrates another schematic deployment diagram of a first processing unit and a second processing unit local to an electronic device, consistent with the disclosed embodiments of the present disclosure. Taking the processing unit shown in FIG. 6 as an example, as shown in FIG. 6, the first third-processing unit is deployed between the second first-processing unit and the third first-processing unit. The second third-processing unit is deployed between the second second-processing unit and the fifth first-processing unit. The third third-processing unit is deployed between the fourth second-processing unit and the seventh first-processing unit. The first, second and third third-processing units are each configured to downsample the input image feature vector, thereby reducing the vector size of the image feature vector.

In addition, the fourth third-processing unit is deployed between the thirteenth first-processing unit and the fourteenth first-processing unit. The fifth third-processing unit is deployed between the twelfth second-processing unit and the seventeenth first-processing unit. The sixth third-processing unit is deployed between the fifteenth second-processing unit and the twentieth first-processing unit. The fourth, fifth and sixth third-processing units are each configured to upsample the input image feature vector, thereby increasing the vector size of the image feature vector.

As such, when the second processing unit is classified into a plurality of layers according to the vector sizes of the image feature vectors processed, in the layers before and after the third processing unit that downsamples the image feature vector, different numbers of second processing units may be deployed. Before the third processing units, the closer the layer is to front, the fewer the deployed second processing units are. After the third processing units, the further back the layer is, the less the deployed second processing units are.

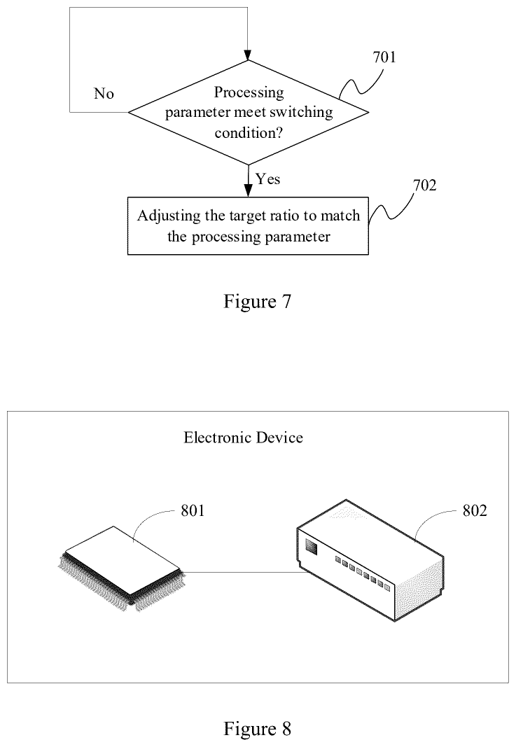

In one embodiment, the target ratio may be adjusted. FIG. 7 illustrates a flow chart for adjusting a target ratio, consistent with the disclosed embodiments of the present disclosure. As shown in FIG. 7, in one embodiment, the data processing method may also include operations S701 and S702.

S701: checking whether the processing parameters meet a switching condition. When the processing parameters meet the switching condition, step 702 may be executed. When the processing parameters do not meet the switching condition, the method may return to S701 to continue to check whether the processing parameters meet the switching condition.

S702: adjusting the target ratio to match the processing parameters and executing S701. That is, in one embodiment, it is detected in real time whether the processing parameters meet the switching condition. When the processing parameters meet the switching condition, the target ratio may be adjusted to match the processing parameters.

The processing parameters may include at least one of the following: the historical generation time of the target data, the processing performance of the processor running the second processing unit, and the data size of the target data. Correspondingly, the switching condition may be: the processing parameters do not match the target ratio.

Specifically, in one embodiment, when the target ratio is a first ratio, the date processing method may determine whether the current processing parameters match the first ratio. When the current processing parameters do not match the first ratio, the target ratio may be adjusted to a second ratio, and at this moment, the second ratio may match the current processing parameters.

The historical generation time of the target data may be obtained by collecting historical operation data of the local processing units of the electronic device. Taking the local image generation model of the electronic device as an example, the historical generation time is the time used by the local image generation model to generate the image historically. The historical generation time represents the efficiency of the local processing units of the electronic device in generating the target data. When the historical generation time is greater than or equal to a first time threshold, the processing efficiency of the local processing units of the electronic device may be relatively low. In this case, the target ratio may be adjusted to match the historical generation time, that is, the number of second processing units that process the image feature vectors with a large vector size may be reduced, thereby reducing the amount of data processed by the local processing units of the electronic device to improve processing efficiency. When the historical generation time is less than or equal to a second time threshold, the processing efficiency of the local processing unit of the electronic device may be relatively high. In this case, the target ratio may be adjusted to match the historical generation time. That is, the number of second processing units processing the image feature vectors with a large vector size may be increased, but may not exceed the number of the second processing units processing the image feature vectors with a small vector size, thereby improving the data processing quality of the processing units. When the historical generation duration is greater than the second duration threshold and less than the first duration threshold, the historical generation duration matches the target ratio, and the target ratio may not be adjusted in this case.

The processing performance of the processor may include at least one of the cache space of the processor, and the computing power of the computing unit of the processor. Taking the processor as an NPU as an example, the cache space of the processor may be the size of the L1 region in the cascade cache of the NPU, and the computing power of the computing unit of the processor may be the core size of the NPU.

For example, when the cache space of the processor is small and/or the computing power of the computing unit of the processor is poor, the target ratio may be adjusted to match the processing performance of the processor. That is, the number of second processing units that process the image feature vectors with a large vector size may be reduced. When the processor cache is large and/or the processor's computing unit has much computing power, the target ratio may be adjusted to match the processing performance of the processor. That is, the number of the second processing units processing the image feature vectors with a large vector size may be increased, but may not exceed the number of the second processing units processing the image feature vectors with a small vector size. When the cache space of the target processor is moderate and/or the computing power of the computing unit of the processor is moderate, the processing performance of the processor matches the target ratio, and the target ratio may not be adjusted in this case.

In addition, the larger the amount of the target data, the greater the processing pressure on the local processing units of the electronic device. In one embodiment, the target ratio may be adjusted according to the data size of the target data. Taking the target data as image data as an example, the data size of the target data may be the image resolution of the target image. The higher the image resolution, the greater the processing pressure on the local processing units of the electronic device.

For example, when the data size of the target data is greater than or equal to a first data size threshold, the target ratio may be adjusted to match the data size of the target data, that is, the number of second processing units processing the image feature vectors with a large vector size may be reduced. When the data size of the target data is less than or equal to a second data size threshold, the target ratio may be adjusted to match the data size of the target data, that is, the number of the second processing units processing the image feature vectors with a large vector size may be increased, but may not exceed the number of the second processing units processing the image feature vectors with a small vector size. When the data volume of the target data is less than the first data volume threshold and greater than the second data volume threshold, the data size of the target data matches the target ratio, and the target ratio may not be adjusted in this case.

It should be noted that the numbers of second processing units corresponding to different target ratios may satisfy a control condition. The control condition may be: a difference in the numbers of the second processing units corresponding to different target ratios is less than or equal to a difference threshold.

In one embodiment, the numbers of the second processing units corresponding to different target ratios may be same. That is, the number of the second processing units before and after the target ratio adjustment may remain unchanged. For example, a part of the second processing units for processing the image feature vectors with a large vector size may be switched to the second processing units for processing the image feature vectors with a small vector size. In this way, the number of the second processing units in the electronic device may not be reduced, but the amount of local data processing in the electronic device may be reduced. Accordingly, the local processing units of the electronic device may expediate the processing of input data.

The present disclosure also provides a neural network processor. The neural network processor may execute a local data processing model. The neural network processor is configured to obtain input data, locally process the input data using a local data processing model to obtain target data, such that the local data processing model may expediate the local processing of the input data.

It should be noted that the local data processing model may be an image generation model or a text generation model. The local data processing model may include a plurality of processing units. Taking the image generation model as an example, as shown in FIG. 2, the data processing model may include a residual processing unit and an attention processing unit.

Specifically, in one embodiment, the local data processing model may be tuned and trained in the neural network processor. The inference framework of the neural network processor may be used to implement a dedicated expediated data processing model, that is, an NPU dedicated large model, such as an NPU large model dedicated to image generation or an NPU large model dedicated to text generation.

It may be learnt from the above descriptions that, in one embodiment, the local data processing model may be executed through a neural network processor in an electronic device, such that the local data processing model may expediate the local processing of the input data. As such, the neural network processor may be used to expediate the operation of the local data processing model. Accordingly, the situation where the data processing model may not be locally executed, may be avoided, and the reliability of data processing may be avoided.

The present disclosure also provides an electronic device. FIG. 8 illustrates a schematic structural diagram of an electronic device consistent with the disclosed embodiments of the present disclosure. Referring to FIG. 8, in one embodiment, the electronic device includes a memory 801 and a processor 802.

The memory 801 is configured for storing a computer program and data generated by executing the computer program.

The processor 802, such as a neural network processor, is configured to execute the computer program to implement the following operations:

Obtaining input data;
Based on the input data, determining an image feature vector and a text feature vector;
Inputting the image feature vector to a first processing unit of the electronic device to obtain an image feature vector output by the first processing unit;
Inputting the text feature vector and the image feature vector output by the first processing unit into a local second processing unit of the electronic device, where the second processing unit is configured to adjust the image feature vector output by the first processing unit according to the correlation between the text feature vector and the image feature vector output by the first processing unit, and then input the adjusted image feature vector to a next first processing unit of the electronic device; and
Based on the processing by a plurality of the first processing units and a plurality of the second processing units, obtaining target data, where the vector sizes of the image feature vectors processed by different first processing units may be same or different, the vector sizes of the image feature vectors processed by the second processing units may be same or different, and the number of times the second processing units process the image feature vectors with a large vector size may be less than the number of times the second processing units process the image feature vectors with a small vector size.

It may be learnt from the above descriptions that, in one embodiment, a local data processing model may be executed through a neural network processor in an electronic device, such that the local data processing model may expediate the local processing of the input data. As such, the neural network processor may be used to expediate the operation of the local data processing model. Accordingly, the situation where the data processing model may not be locally executed may be avoided, and the reliability of data processing may be improved.

Taking the scenario of running an image generation model, such as stable diffusion, in the NPU as an example, the technical solution of the present disclosure is described as follows.

The image generation model may be a Unet structure, including a plurality of residual processing units and a plurality of attention processing units. The residual processing unit may also be called a Resnet processing unit. The residual processing unit is configured to process an input image feature vector, such that the input image feature vector may be denoised. Specifically, the processing may include convolution, pooling, max pooling, relu and other processing. Accordingly, the residual processing unit may output a denoised image feature vector. The attention processing unit may also be called a cross attention processing unit. The attention processing unit is configured to, according to the correlation between the input text feature vector and the image feature vector output by the residual processing unit connected to the attention processing unit, adjust the image feature vector output by the residual processing unit, such that the image feature vector output by the attention processing unit and the input text feature vector may meet a correlation condition. Afterwards, the attention processing unit may input the output image feature vector into a next residual processing unit in the local processing model, and so on, until the local image generation model generates a target image (i.e., target data) based on the image feature vector output by the last attention processing unit or residual processing model.

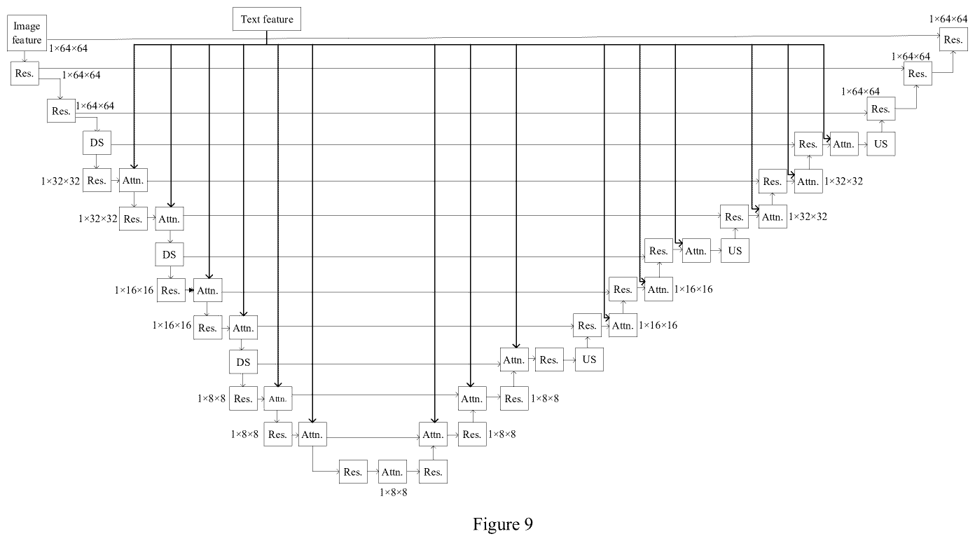

FIG. 9 illustrates a schematic structural diagram of an image generation model local to an electronic device, consistent with the disclosed embodiments of the present disclosure. As shown in FIG. 9, the text feature vector corresponding to the input data is an input of each attention processing unit, such as a text feature vector corresponding to the input text “a cat”. The image feature vector corresponding to the input data is used as an input of the first residual processing unit on the left, such as a 1×64×64 image feature vector. The first residual processing unit processes the 1×64×64 image feature vector and inputs the obtained image feature vector into the second residual processing unit. The second residual processing unit processes the input image feature vector and inputs the obtained image feature vector into a first downsampling processing unit. The first downsampling processing unit reduces the vector size of the 1×64×64 image feature vector, and inputs the obtained 1×32×32 image feature vector into the third residual processing unit. The third residual processing unit processes the image feature vector and inputs the obtained image feature vector into the first attention processing unit. The first attention processing unit adjusts the input image feature vector according to the correlation between the input text feature vector and the input image feature vector, and inputs the adjusted image feature vector into the fourth residual processing unit. The fourth residual processing unit processes the image feature vector and inputs the obtained image feature vector into the second attention processing unit. The second attention processing unit adjusts the input image feature vector according to the correlation between the input text feature data and the input image feature vector, and inputs the adjusted image feature vector into a second downsampling processing unit. The downsampling processing unit reduces the vector size of the 1×32×32 image feature vector, and inputs the obtained 1×16×16 image feature vector into the fifth residual processing unit. The fifth residual processing unit processes the image feature vector and inputs the obtained image feature vector into the third attention processing unit, and so on, until the thirteenth residual processing unit processes the image feature vector, and the obtained image feature vector is input to a first upsampling processing unit. The upsampling processing unit increases the vector size of the 1×8×8 image feature vector, and inputs the obtained 1×16×16 image feature vector into the fourteenth residual processing unit.

The fourteenth residual processing unit processes the image feature vector, and inputs the obtained image feature vector into the ninth attention processing unit. The ninth attention processing unit adjusts the input image feature vector according to the correlation between the input text feature data and the input image feature vector, and then inputs the adjusted image feature vector to the fifteenth residual processing unit, and so on, until the last residual processing unit processes the image feature vector and outputs the obtained image feature vector. According to the output image features, the target data may be obtained, such as a target image generated according to the input text in the input data.

As may be seen from FIG. 9, in one embodiment, the number of the attention processing units for processing the image feature vectors with a large vector size is smaller than the number of the attention processing units for processing the image feature vectors with a small vector size. Since the amount of data processing required for processing an image feature vector with a large vector size is large, when the number of the attention processing units required for processing the image feature vectors with a large vector size is reduced, the local resource consumption of the electronic device may be reduced.

In the present disclosure, when the image generation model is locally deployed, the deployment of the attention processing units may be adjusted and retrained. For example, in a Unet structure, the attention processing units may be deployed in a ratio of 1:2:4 or 1:5:5. The number of the attention processing units may remain unchanged, but since more attention processing units are used on processing the image feature vectors with a smaller vector size, the amount of computation required may be greatly reduced. Accordingly, the generation speed of the local image generation model may be improved, and the memory consumption during inference may be reduced (since the cross attention calculations occur in the Unet structure with a smaller vector size, the data amount and calculation amount for matrix calculations may be reduced).

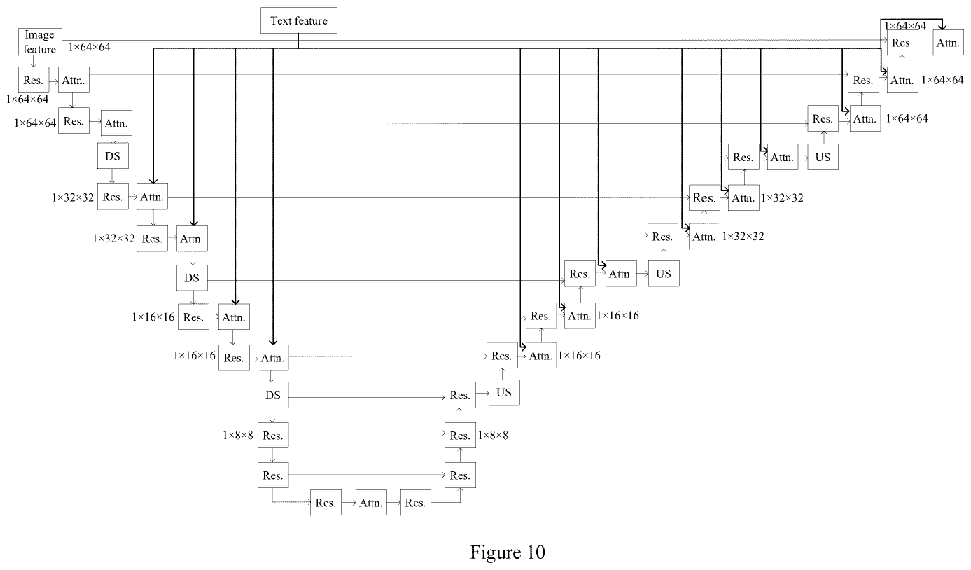

FIG. 10 illustrates a schematic diagram of an image generation model in existing technology. Compared with the structure shown in FIG. 10, the structure shown in FIG. 9 may improve the local processing speed by approximately 15% to 20%. In addition, optimizations of models, such as the LCM model and the Lighting model, may also be expediated using the technical solutions of the present disclosure.

In addition, when operating on an NPU, the image generation model of the present disclosure may have advantages. NPU computing is essentially a fast matrix linear operation, and the core of NPU computing is fast calculation of small matrices. As such, the cascade cache in the computing core may be small. In addition, the present disclosure may reduce the requirements of the cascade cache in hardware computing of the attention processing units, and the calculation may be completed in a cascade cache. As such, executing the image generation model on an NPU may be advantageous. Compared with a Unet structure design in existing technology, executing the image generation model on an NPU may increase the speed by approximately 25%˜30%.

Those skilled in the art may appreciate that the units and algorithm operations of each embodiment of the present disclosure may be implemented by electronic hardware, computer software, or a combination thereof. In the present disclosure, to illustrate the interchangeability of hardware and software, the components and operations of each embodiment are generally described in terms of functions. Whether the functions are executed by hardware or software depends on specific applications and design constraints of a technical solution. Without departing from the spirit or scope of the present disclosure, those skilled in the art may use a modified approach to implement a function for a specific application.

The operations or algorithms in the present disclosure may be implemented using hardware, a software module executed by a processor, or a combination thereof. The software module may be stored in random access memory (RAM), memory, read-only memory (ROM), electrically programmable ROM, electrically erasable programmable ROM, registers, hard disks, removable disks, CD-ROMs, or other form of storage media known in the art.

As disclosed, the technical solutions of the present disclosure have the following advantages.

In the data processing method provided by the present disclosure, the local data processing model may be executed through a neural network processor in an electronic device, such that the local data processing model may expediate the local processing of the input data. As such, the neural network processor may be used to expediate the operation of the local data processing model. Accordingly, the data processing model may be locally deployed and executed, and the reliability of data processing may be improved.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. A data processing method, comprising:
obtaining input data;
based on the input data, determining an image feature vector and a text feature vector; and inputting the image feature vector into a first processing unit local to an electronic device, to obtain an image feature vector output by the first processing unit;
inputting the text feature vector and the image feature vector output by the first processing unit into a second processing unit local to the electronic device, wherein the second processing unit is configured to, according to correlation between the text feature vector and the image feature vector output by the first processing unit, adjust the image feature vector output by the first processing unit, and then input the image feature vector after an adjustment by the second processing unit into a next first processing unit local to the electronic device; and
based on processing by a plurality of the first processing units and a plurality of the second processing units, obtaining target data, the target data being related to the input data,
wherein:
vector sizes of the image feature vectors processed by different first processing units are same or different, and thereby vector sizes of the image feature vectors processed by the second processing units are same or different; and
a quantity of times the second processing units process the image feature vectors with a large vector size is less than a quantity of times the second processing units process the image feature vectors with a small vector size.

2. The method according to claim 1, wherein:
the second processing units are classified into a plurality of layers according to the vector sizes of the image feature vectors processed by the second processing units; and
a quantity of the second processing units in each of the plurality of layers is in a target ratio.

3. The method according to claim 2, wherein:
the first processing units and the second processing units run on a processor of an electronic device; and
the target ratio is related to processing performance of the processor, and/or the target ratio is related to a data size of the target data.

4. The method according to claim 1, further comprising:
deploying a third processing unit between two adjacent first processing units, or deploying the third processing unit between a first processing unit of the first processing units and an adjacent second processing unit.

5. The method according to claim 4, wherein:
the third processing unit is configured to upsample the image feature vector output by the second processing unit or the first processing unit to obtain an image feature vector with an increased vector size, and provide the image feature vector with an increased vector size to a next first processing unit of the first processing units; or,
the third processing unit is configured to downsample the image feature vector output by the second processing unit or the first processing unit to obtain an image feature vector with a reduced vector size, and provide the image feature vector with a reduced vector size to a next first processing unit of the first processing units.

6. The method according to claim 3, further comprising:
checking whether a processing parameter meets a switching condition; and
when the processing parameter meets the switching condition, adjusting the target ratio to match the processing parameter.

7. The method according to claim 6, wherein:
the processing parameter includes at least one of parameters including a historical generation time of the target data, processing performance of the processor running the second processing unit, or a data size of the target data.

8. The method according to claim 6, wherein:
quantities of the second processing units corresponding to different target ratios of the target ratio satisfy a control condition.

9. An electronic device, comprising one or more processors and a memory containing a computer program that, when being executed, causes the one or more processors to perform:
obtaining input data;
based on the input data, determining an image feature vector and a text feature vector; and inputting the image feature vector into a first processing unit local to an electronic device, to obtain an image feature vector output by the first processing unit;
inputting the text feature vector and the image feature vector output by the first processing unit into a second processing unit local to the electronic device, wherein the second processing unit is configured to, according to correlation between the text feature vector and the image feature vector output by the first processing unit, adjust the image feature vector output by the first processing unit, and then input the image feature vector after an adjustment by the second processing unit into a next first processing unit local to the electronic device; and
based on processing by a plurality of the first processing units and a plurality of the second processing units, obtaining target data, the target data being related to the input data,
wherein:
vector sizes of the image feature vectors processed by different first processing units are same or different, and thereby vector sizes of the image feature vectors processed by the second processing units are same or different; and
a quantity of times the second processing units process the image feature vectors with a large vector size is less than a quantity of times the second processing units process the image feature vectors with a small vector size.

10. The device according to claim 9, wherein:
the second processing units are classified into a plurality of layers according to the vector sizes of the image feature vectors processed by the second processing units; and
a quantity of the second processing units in each of the plurality of layers is in a target ratio.

11. The device according to claim 10, wherein:
the first processing units and the second processing units run on the one or more processors of the electronic device; and
the target ratio is related to processing performance of the one or more processors, and/or the target ratio is related to a data size of the target data.

12. The device according to claim 9, wherein the one or more processors are further configured to perform:
deploying a third processing unit between two adjacent first processing units, or deploying the third processing unit between a first processing unit of the first processing units and an adjacent second processing unit.

13. The device according to claim 12, wherein:
the third processing unit is configured to upsample the image feature vector output by the second processing unit or the first processing unit to obtain an image feature vector with an increased vector size, and provide the image feature vector with an increased vector size to a next first processing unit of the first processing units; or
the third processing unit is configured to downsample the image feature vector output by the second processing unit or the first processing unit to obtain an image feature vector with a reduced vector size, and provide the image feature vector with a reduced vector size to a next first processing unit of the first processing units.

14. The device according to claim 11, wherein the one or more processors are further
configured to perform:
checking whether a processing parameter meets a switching condition; and
when the processing parameter meets the switching condition, adjusting the target ratio to match the processing parameter.

15. The device according to claim 14, wherein:
the processing parameter includes at least one of parameters including a historical generation time of the target data, processing performance of a processor, of the one or more processors, running the second processing unit, or a data size of the target data.

16. The device according to claim 14, wherein:
quantities of the second processing units corresponding to different target ratios of the target ratio satisfy a control condition

17. The device according to claim 9, wherein:
data generated by executing the computer program are stored in the memory.

18. A non-transitory computer readable storage medium containing a computer program that, when being executed, causes at least one processor to perform:
obtaining input data;
based on the input data, determining an image feature vector and a text feature vector; and inputting the image feature vector into a first processing unit local to an electronic device, to obtain an image feature vector output by the first processing unit;
inputting the text feature vector and the image feature vector output by the first processing unit into a second processing unit local to the electronic device, wherein the second processing unit is configured to, according to correlation between the text feature vector and the image feature vector output by the first processing unit, adjust the image feature vector output by the first processing unit, and then input the image feature vector after an adjustment by the second processing unit into a next first processing unit local to the electronic device; and
based on processing by a plurality of the first processing units and a plurality of the second processing units, obtaining target data, the target data being related to the input data,
wherein:
vector sizes of the image feature vectors processed by different first processing units are same or different, and thereby vector sizes of the image feature vectors processed by the second processing units are same or different; and
a quantity of times the second processing units process the image feature vectors with a large vector size is less than a quantity of times the second processing units process the image feature vectors with a small vector size.

19. The storage medium according to claim 18, wherein:
the second processing units are classified into a plurality of layers according to the vector sizes of the image feature vectors processed by the second processing units; and
a quantity of the second processing units in each of the plurality of layers is in a target ratio.

20. The storage medium according to claim 18, wherein the at least one processor is further configured to perform:
deploying a third processing unit between two adjacent first processing units, or deploying the third processing unit between a first processing unit of the first processing units and an adjacent second processing unit.
